(19) United States
(12) Patent Application Publication
(10) Pub. No.: US 2026/0046546 A1
(43) Pub. Date: Feb. 12, 2026

(54) HEADSET

(71) Applicant: MERRY ELECTRONICS (SUZHOU) CO., LTD., Jiangsu Province (CN)

(72) Inventors: Jiawei ZHU, Jiangsu Province (CN); Mingya LUO, Jiangsu Province (CN)

(73) Assignee: MERRY ELECTRONICS (SUZHOU) CO., LTD., Jiangsu Province (CN)

(21) Appl. No.: 19/287,134

(22) Filed: Jul. 31, 2025

(30) Foreign Application Priority Data
Aug. 7, 2024 (CN) 202411080968.X

(51) Int. Cl. H04R 1/10; H04R 1/34

(52) U.S. Cl. CPC H04R 1/1075; H04R 1/1008; H04R 1/105; H04R 1/345

(57) ABSTRACT

Provided is a headset including a speaker and a wearing part. The speaker includes a diaphragm. The wearing part includes a cavity and a sound output port. The cavity includes an accommodating room and an acoustic channel. The speaker is arranged in the accommodating room. The diaphragm is arranged facing the acoustic channel. The sound output port is arranged on an end of the acoustic channel away from the accommodating room. The acoustic channel extends curvedly in a reference plane. In the sound propagation direction, the cross-sectional area of the acoustic channel progressively increases.

### CROSS-REFERENCE TO RELATED APPLICATION

This application claims the benefit of Chinese Patent Application No. 202411080968.X, filed on Aug. 7, 2024, entitled “Headset”, which is incorporated herein by reference in its entirety.

### FIELD

The present disclosure relates to the field of electro-acoustic conversion, and more particularly to a headset.

### BACKGROUND

A speaker of a headset, such as earphone or intelligent glass, is close to human's ear, allowing sound outputted by the speaker to directly enter human's ear. Therefore, the quality demand of the speaker is high. In addition, the headset has a small space, so it is difficulty to arrange the speaker. How to mount the speaker in the headset and ensure the quality of the sound outputted by the headset is a question that needs to be addressed.

### SUMMARY

Embodiments of the present disclosure provide a headset. The headset includes: a speaker including a diaphragm; and a wearing part including a cavity and a sound output port. The cavity includes an accommodating room and an acoustic channel, a first end of the acoustic channel extends to the accommodating room, a second end of the acoustic channel is communicated with the sound output port, the speaker is arranged in the accommodating room, and the diaphragm faces the acoustic channel. At least a segment of the acoustic channel extends curvedly in a reference plane, and in the extending direction of the acoustic channel, a sectional area of the acoustic channel at a position close to the sound output port is greater than a sectional area of the acoustic channel at a position away from the sound output port.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 is a perspective view of a headset viewing from a side according to a first embodiment of the present disclosure;

FIG. 2 is a perspective view of the headset viewing from another side according to the first embodiment of the present disclosure;

FIG. 3 is a schematic view of the headset provided in the first embodiment in a wearing state according to an embodiment of the present disclosure;

FIG. 4 is a schematic view of the headset provided in the first embodiment in a wearing state according to another embodiment of the present disclosure;

FIG. 5 is an exploded view of the headset in the first embodiment of the present disclosure;

FIG. 6 is a partial schematic view of the headset in the first embodiment of the present disclosure;

FIG. 7 is a cross-sectional view of a wearing part in the first embodiment of the present disclosure;

FIG. 8 is a perspective view of a wearing part according to a second embodiment of the present disclosure;

FIG. 9 is a cross-sectional view of a temple in the second embodiment according to an embodiment of the present disclosure;

FIG. 10 is a cross-sectional view of the temple in the second embodiment according to another embodiment of the present disclosure;

FIG. 11 is a schematic view of the temple in the second embodiment according to an embodiment of the present disclosure;

FIG. 12 is a schematic view of the temple in the second embodiment according to an embodiment of the present disclosure; and

FIG. 13 is a cross-sectional view taken along line C-C in FIG. 9; and

FIG. 14 is a cross-sectional view taken along line D-D in FIG. 10.

### DESCRIPTION OF REFERENCE SIGNS

1: wearing part; 11: housing: 111: acoustic guiding tube;
1111: first curved segment; 1112: second curved segment;
1113: third curved segment; 1114: connection cap;
12: ear hanging region; 2: speaker; 21: diaphragm;
3: cavity; 31: accommodating room; 32: acoustic channel;
321: straight section; 322: curved section; 33: sound output port;
4: temple; 51: first edge; 52: second edge; 6: net;
A: reference plane; A1: reference point; B: avoidance space.

### DETAILED DESCRIPTION

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, it should be understood by those skilled in the art, the drawings herein are provided for the purpose of illustration, and the drawings are not necessarily to scale.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

Further, spatially relative terms, such as “beneath,” “below,” “lower,” “above,” “upper” and the like, may be used herein for case of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

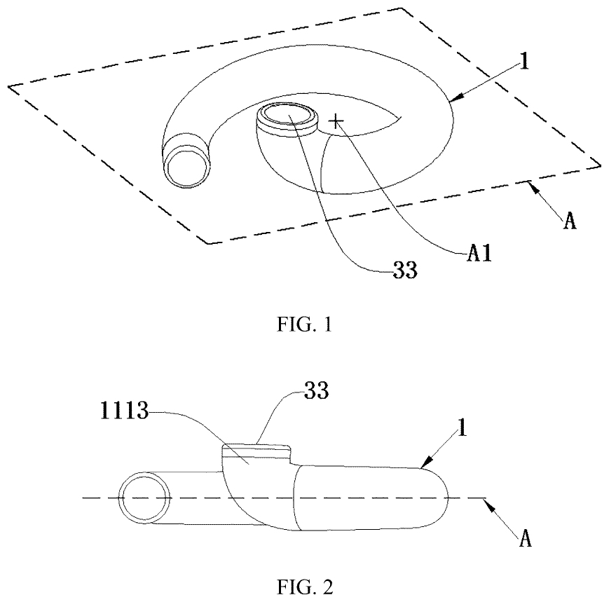

FIG. 1 to FIG. 7 illustrate a structure of a headset provided by a first embodiment of the present disclosure. FIG. 8 to FIG. 14 illustrate a structure of a headset provided by a second embodiment of the present disclosure.

FIG. 1 and FIG. 2 are perspective views of the headset provided by the first embodiment of the present disclosure. FIG. 1 and FIG. 2 show a reference plane A and a sound output port 33 directing one side of the reference plane A. The reference plane A passes through a wearing part 1. FIG. 1 also shows a reference point A1 arranged in the reference plane A.

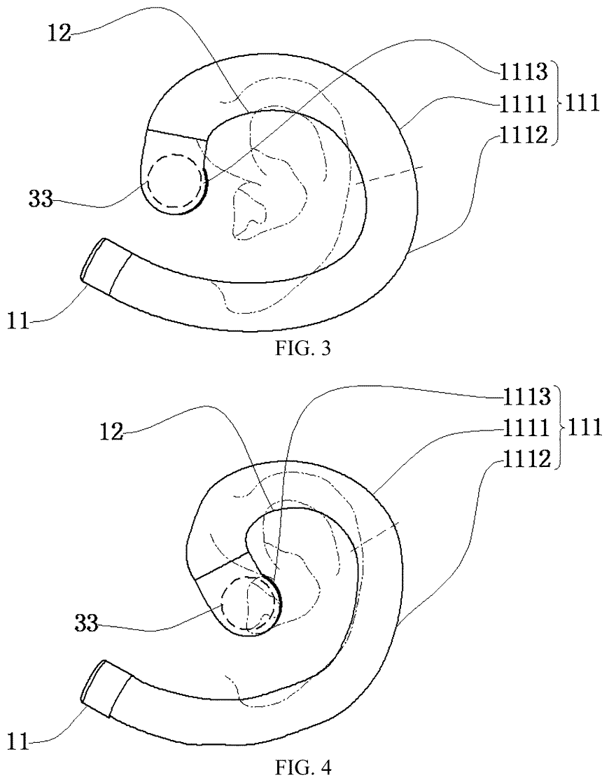

FIG. 3 and FIG. 4 are schematic views showing the headset in the wearing state in the first embodiment. In FIG. 3 and FIG. 4, an approximate outline of a left ear is illustrated by dot dash lines. In embodiments of the present disclosure, the headset includes a wearing part 1. The wearing part 1 is arranged on a side of a head. The wearing part 1 includes an acoustic guiding tube 111 surrounding an ear and a sound output port 33 arranged at an end of the acoustic guiding tube 111.

FIG. 3 illustrates a specific form of the headset. In FIG. 3, the sound output port 33 is configured toward a side of a head of a user and staggered with an ear hole of the user. The sound output port 33 may be arranged at the tragus or arranged in a front side region of the tragus, and may extend from the earlobe to a front side of the head. Therefore, a part of the acoustic guiding tube 111 is located in an inner side of the tragus, that is, is sandwiched between the tragus and the head. In this way, the headset is worn on the head.

FIG. 4 illustrates another specific form of the headset. In FIG. 4, the acoustic guiding tube 111 extends from a front edge (that is, the connection position between the antihelix and the side of the head) of the antihelix to the rear side and under side of the car of the user, and extends from the earlobe to the front side of the head. In addition, the curved degree of the acoustic guiding tube 111 is greater such that the acoustic guiding tube 111 faces the ear hole.

It is noted that the reference plane A in the present disclosure is a virtual plane, the reference point A1 is a virtual point, and the reference plane A and the reference point A1 do not physically exist in the real product. In the present embodiment, at least a part of the acoustic guiding tube 111 is located in the reference plane A, at least a part of the acoustic guiding tube 111 is configured to extend along an extending direction in the reference plane A and surround the reference point A1. In this way, the structure of the wearing part 1 is more regular, and it is easy for the user to wear.

In some embodiments, as shown in FIG. 2, the reference plane A is a flat plane. In the present embodiment, each of the first curved segment 1111 and the second curved segment 1112 of the acoustic guiding tube 111 is symmetrical with respect to the reference plane A. That is, a center of the acoustic guiding tube 111 is in the reference plane A, and thus, the headset has a more aesthetically appearance.

In some embodiments, the reference plane A is a curved plane with a certain degree of curvature, and the acoustic guiding tube 111 may extend in a direction perpendicular to the reference plane A. In the present embodiment, the extending direction of the acoustic guiding tube 111 is adjusted according to the structure of human's ear. Therefore, the wearing part 1 better meets the ergonomic design, and the user feels more comfortable when wearing the headset.

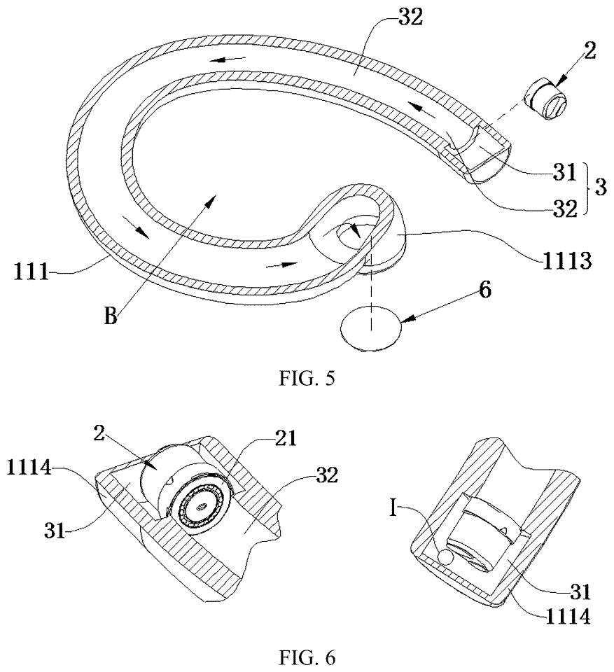

FIG. 5 is an exploded view of the headset in the first embodiment of the present disclosure. The arrows in FIG. 5 show the propagation direction of the sound wave in the acoustic channel 32.

In some embodiments, as shown in FIG. 1 to FIG. 5, the headset may be used as an ear-hook earphone, and the ear-hook earphone may be a wired earphone or a wireless earphone. According to the form of the sound output port 33, the ear-hook earphone may be an in-ear earphone or an open earphone.

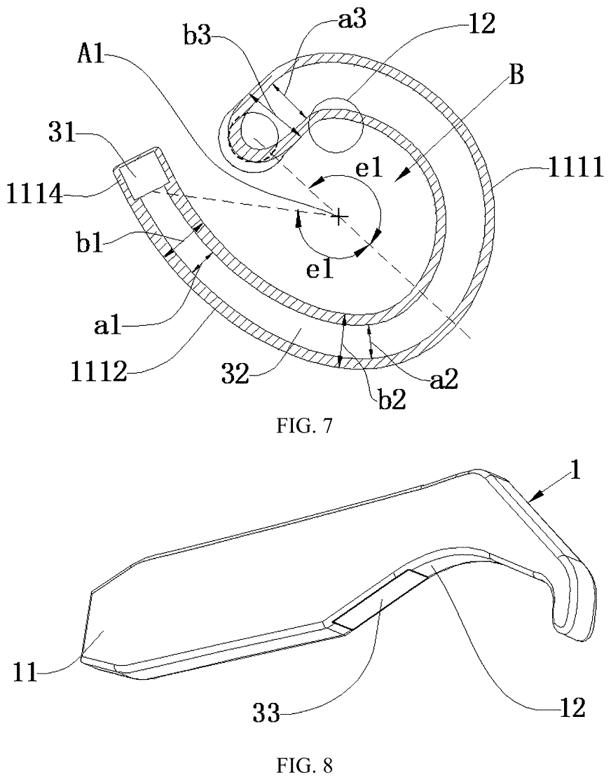

FIG. 6 is a partial schematic view of the headset in the first embodiment of the present disclosure. FIG. 7 is a cross-sectional view of the wearing part 1 in the first embodiment of the present disclosure. In FIGS. 7, a1, a2, and a3 are inner diameters of the acoustic guiding tube 111 at different positions, and b1, b2, and b3 are outer diameters of the acoustic guiding tube 111 at different positions.

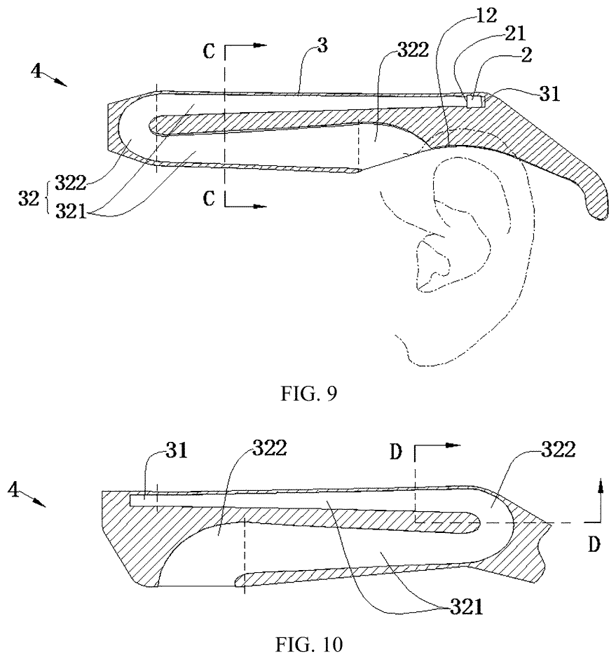

FIG. 8 is a perspective view of a temple 4 according to a second embodiment of the present disclosure. FIG. 9 to FIG. 12 are cross-sectional views of the temple 4 according to various embodiments of the present disclosure.

The wearing part 1 in the present embodiment may be used in a headset. The headset may be used for providing virtual reality, augmented reality, mixed reality, and the like. The headset includes a display module, two wearing parts 1, and a tie. First ends of the two wearing parts 1 are connected to the display module, and second ends of the two wearing parts 1 are connected to the tie, thereby facilitating the user to wear the headset. The wearing part 1 is a temple 4 connected to a frame of the smart glasses.

In some embodiments, as shown in FIG. 2, FIG. 6, FIG. 8, and FIG. 9, the headset includes the wearing part 1 and the speaker 2, and the speaker 2 includes the diaphragm 21.

Please refer to FIG. 5 again, the wearing part 1 includes a cavity 3 and a sound output port 33. The cavity 3 includes an accommodating room 31 and an acoustic channel 32. One end of the acoustic channel 32 extends to the accommodating room 31, and another end of the acoustic channel 32 is communicated with the sound output port 33. The speaker 2 is arranged in the accommodating room 31, and the diaphragm 21 faces the acoustic channel 32.

For example, the acoustic channel 32 includes a first port and a second port, the first port is connected to the accommodating room 31, and the second port extends to the outer surface of the wearing part 1 to form the sound output port 33. In the present embodiment, the cavity 3 includes the accommodating room 31 and the acoustic channel 32, and the speaker 2 is arranged in the accommodating room 31, thereby simplifying the outer structure of the wearing part 1 and making the appearance of the wearing part 1 more beautiful. In addition, the sound wave generated by the speaker 2 is all limited by the cavity 3, which avoids sound leakage of the speaker 2.

In some embodiments, the diaphragm 21 faces the acoustic channel 32 via the first port, and the speaker 2 is configured such that a side of the diaphragm 21 covers the first port. Therefore, the sound wave generated by the diaphragm 21 is all transmitted along the extending direction of the acoustic guiding tube 111, preventing the sound from leakage from the accommodating room 31.

In addition, at least a segment of the acoustic channel 32 extends curvedly in a reference plane A, and in the extending direction of the acoustic channel 32, a sectional area of the acoustic channel 32 at a position close to the sound output port 33 is greater than a sectional area of the acoustic channel 32 at a position away from the sound output port 33. That is, the acoustic channel 32 that extends in the reference plane A has a sectional area progressively increasing in the extending direction of the acoustic channel 32 from the accommodating room 31 to the sound output port 33.

To sum up, in the headset in embodiments of the present disclosure, the wearing part 1 is provided with an accommodating room 31 and an acoustic channel 32, the speaker 2 is arranged in the accommodating room 31, the diaphragm 21 faces the acoustic channel 32, and the sound output port 33 is arranged on an end of the acoustic guiding tube 111 away from the accommodating room 31. The acoustic channel 32 extends curvedly in the reference plane A. Therefore, the space occupied by the acoustic channel 32 is small, the acoustic channel 32 may be arranged in a small region, the volume of the wearing part 1 is reduced, and it is easy for the user to wear the headset. In addition, the length and the cross-sectional area of the acoustic channel 32 are increased as much as possible, and the sound outputted from the sound output port 33 is more natural. Furthermore, the sound wave (pressure wave) generated by the diaphragm 21 is propagated along the curved direction in the acoustic channel 32. In the sound propagation direction, the cross-sectional area of the acoustic channel 32 progressively increases, and thus, the pressure and amplitude of the sound wave vary with the propagation distance of the sound wave in the acoustic channel 32 and vary with the changing of the cross section. When the sound wave travels from the first port to the second port, the pressure of the sound wave decreases as the cross-sectional area increases, and the amplitude increases accordingly. Therefore, the direction of the sound wave outputted from the sound output port is more concentrate, the loudness is greater, and the distortion of the sound wave is reduced. In another aspect, due to the arrangement of the speaker 2 in the wearing part 1, the configuration requirement of parameters of the speaker 2 is reduced without affecting the quality of the sound outputted by the headset, and the cost of the speaker 2 is reduced.

It is noted that the acoustic channel 32 in embodiments of the present disclosure may be an inner cavity of a horn structure. The changing trend of the sectional area of the acoustic channel 32 may be configured in different forms, such as a conical form, an exponential form, or a hyperbola form.

For example, the sectional area of the acoustic channel 32 is configured in an exponential form, and the sectional area of the acoustic channel 32 at the target position may be calculated according to the following formula:

$$S = {S}_{0} {e}^{δ x}$$

In the above formula, x is the distance between the target position and the first port along the extending direction of the acoustic guiding tube 111, δ is a curved index, e is natural constant, S₀ is the sectional area of the first port (the sectional area of the throat portion), and S is the sectional area at the target position.

In some embodiments, the cross-sectional shape of the acoustic channel 32 may be a circle, an oval, a rectangle or a trapezoid shape. Those skilled in the art may design the shape according to the form of the wearing part 1. For example, the wearing part 1 is small, but it needs to increase the sectional area of the acoustic channel 32 as much as possible, the acoustic channel 32 may be designed to have a circle shape. In addition, a net 6 is arranged at the sound output port 33 to prevent dirt from entering the acoustic channel 32.

In some embodiments, to ensure the sound quality of the headset, the sectional area of the first port may be 0.5 mm² to 100 mm², the length of the acoustic channel 32 may be 1 cm to 20 cm, and the area of the sound output port 33 is less than or equal to 300 mm².

In some embodiments, as shown in FIG. 3, FIG. 4, and FIG. 8, the wearing part 1 includes a housing 11. The housing 11 is provided with the cavity 3, and the outer surface of the housing 11 is provided with an ear hanging region 12 and the sound output port 33. In embodiments of the present disclosure, the wearing part 1 may be hanged on the ear of the user through the ear hanging region 12, so that the sound generated by the sound output port 33 is closer to the ear of the user.

In some embodiments, the ear hanging region 12 is in the reference plane A, so that the ear hanging region 12 and the acoustic channel 32 are in the same plane. In this way, the wearing part 1 is arranged on the ear of the user more stably.

In some embodiments, as shown in FIG. 3 to FIG. 5, the housing 11 includes the acoustic guiding tube 111, and the inner wall of the acoustic guiding tube 111 forms the acoustic channel 32. The acoustic guiding tube 111 includes a first curved segment 1111 along the extending direction of the acoustic guiding tube 111. The first curved segment 1111 extends in the reference plane, and the first curved segment 1111 is curved to form the ear hanging region 12.

In the present embodiment, the first curved segment 1111 extends curvedly towards the above of the sound output port 33, and the bottom of the first curved segment 1111 forms the ear hanging region 12. When the wearing part 1 is arranged on the ear of the user, the first curved segment 1111 extends from the front side of the ear and along the front edge of the helix, and extends to a side of the auricle facing the head, and thereby, the ear hanging region 12 is hanged on the front edge of the helix. Therefore, the wearing part 1 is mounted by the first curved segment 1111, the sound wave is transmitted by the first curved segment 1111, the appearance of the wearing part 1 is more concise and beautiful.

In some embodiments, as shown in FIG. 1 and FIG. 7, a reference point A1 is in the reference plane A. Please further refer to FIG. 3 and FIG. 4, along the extending direction of the acoustic guiding tube 111, the acoustic guiding tube 111 further includes a second curved segment 1112 extending in the reference plane A. The second curved segment 1112 is connected to an end of the first curved segment 1111 away from the sound output port 33.

Both the second curved segment 1112 and the first curved segment 1111 extend around the reference point A and are curved away from the reference point A, and the second curved segment 1112 and the car hanging region 12 are disposed opposite to each other and spaced apart from each other. That is, along the extending direction of the reference plane A, the first curved segment 1111 and the second curved segment 1112 are curved towards the outer side of the central region of the acoustic guiding tube 111, and the first curved segment 1111 and the second curved segment 1112 extend smoothly in the reference plane A.

The headset in FIG. 3 and FIG. 4 is arranged on the left ear, the first curved segment 1111 and the second curved segment 1112 extend curvedly in the clockwise, and the second curved segment 1112 extends to the bottom of the first curved segment 1111. Therefore, the second curved segment 1112 surrounds the auricle and is on the inner side of the auricle, ensuring that the acoustic guiding tube 111 and the auricle fix the wearing part 1.

In some embodiments, as shown in FIG. 3 to FIG. 6, the housing 11 further includes a connection cap 1114. The connection cap 1114 includes the accommodating room 31. The connection cap 1114 is connected to the end of the second curved segment 1112 away from the first curved segment 1111. In the present embodiment, the connection cap 1114 is provided at the end portion of the second curved segment 1112, and is used for accommodating the speaker 2.

For example, the speaker 2 is firstly mounted in the accommodating room 31, and then the connection cap 1114 is bonded to the end portion of the first curved segment 1111, thereby ensuring the stability of the connection of the acoustic guiding tube 111.

In some embodiments, as shown in FIG. 2 to FIG. 5, along the extending direction of the acoustic guiding tube 111, the acoustic guiding tube 111 further includes a third curved segment 1113. The third curved segment 1113 is curved to a side of the reference plane A. An end of the third curved segment 1113 is connected to the first curved segment 1111 away from the second curved segment 1112, and anther end of the third curved segment 1113 forms the sound output port 33. That is, the sound output port 33 is not in the same plane with the first curved segment 1111 and the second curved segment 1112. In the present embodiment, the third curved segment 1113 is used for guiding the sound wave to the direction towards the ear of the user, so that the sound wave outputted from the sound output port 33 has better directivity and sound leakage of the headset is reduced.

In some embodiments, as shown in FIG. 3 to FIG. 4, the curved degree of the second curved segment 1112 is less than the curved degree of the first curved segment 1111. Please further refer to FIG. 5, a side of the second curved segment 1112 facing the first curved segment 1111 forms an avoidance space B.

In the present embodiment, the acoustic guiding tube 111 is curved to form the avoidance space B which is used for avoiding the auricle. In addition, the curved degree of the second curved segment 1112 is less than the curved degree of the first curved segment 1111. Therefore, the top of the acoustic guiding tube 111 can be hanged on the inner side of the auricle, and the tail of the acoustic guiding tube 111 extends around the bottom of the earlobe and extends to the front lower side of the ear. In this way, the acoustic guiding tube 111 better fits the contour of the auricle, and the uncomfortableness of the ear of the user when the user wears the headset for a long time is reduced.

In some embodiments, as shown in FIG. 7, the curved angle of the first curved segment 1111 with respect to the reference point A1 is e1, and the curved angle of the second curved segment 1112 with respect to the reference point A1 is e2. The angle e1 is from 150 degrees to 180 degrees, and the angle e2 is from 115 degrees to 145 degrees.

In some embodiments, both the cross section of the inner wall of the acoustic guiding tube 111 and the cross section of the outer wall of the acoustic guiding tube 111 are circle. In addition, the thickness of wall of the acoustic guiding tube 111 is configured to be constant. As shown in FIG. 2 and FIG. 7, a1, a2, a3 are inner diameters of the acoustic guiding tube 111 at different positions along the sound propagation direction, and a1, a2, and a3 progressively increase, b1, b2, and b3 are outer diameters of the acoustic guiding tube 111 at different positions along the sound propagation direction, and b1, b2, and b3 progressively increase. The difference between a1 and b1, the difference between a2 and b2, and the difference between a3 and b3 are equal. Therefore, the thickness of the wall of the acoustic guiding tube 111 is constant, thereby reducing the overall weight of the wearing part 1.

In some embodiments, the headsets are provided in pair, the two wearing parts 1 of the two headsets are configured to be mirror symmetrical to each other, and thus the two headsets match shapes of two cars respectively.

In some embodiments, the headset may be applied in a Bluetooth carphone, and the Bluetooth earphone includes the wearing part 1, the speaker 2, a Bluetooth module, a battery, and a wireless power receiving module. The Bluetooth module, the battery, and the wireless power receiving module are arranged in the accommodating room 31 (as shown in a region I in FIG. 6), and the battery is electrically connected to the Bluetooth module, the wireless power receiving module, and the speaker 2. For example, the cavity 3 is an enclosed structure. The wireless power receiving module receives electric energy provided by a wireless power transmitting module outside the Bluetooth carphone, and powers the speaker 2 and the Bluetooth module.

In another embodiment, the cross section of the acoustic guiding tube 111 of the headset is configured to be a ring shape, the cross-sectional area of the first port is 7.069 mm², the cross-sectional area of the second port is 28.274 mm², the length of the acoustic guiding tube 111 is 0.09 m, and the curved index is 15.40327.

In some embodiments, as shown in FIG. 8 and FIG. 9, the headset is smart glasses, the wearing part 1 is a temple 4, the temple 4 includes the acoustic channel 32 and the car hanging region 12, and the car hanging region 12 and the sound output port 33 are both disposed at the bottom of the temple 4. The temple 4 in embodiments of the present disclosure may be used in smart glasses or a head-mounted display device for virtual reality or augmented reality. For example, the headset is the head-mounted display device and includes two temples 4. When the user wears the head-mounted display device, the two temples 4 are arranged at two ears of the user, and the sound output port 33 is arranged on the lateral side of the head, thereby making the user hear the audio better.

In some embodiments, as shown in FIG. 9 to FIG. 11, along the extending direction of the acoustic channel 32, the acoustic channel 32 includes at least one straight section 321 and at least one curved section 322. The straight section 321 extends along the length direction of the temple 4, and the curved section 322 is bent from the straight section 321 towards the bottom of the temple 4.

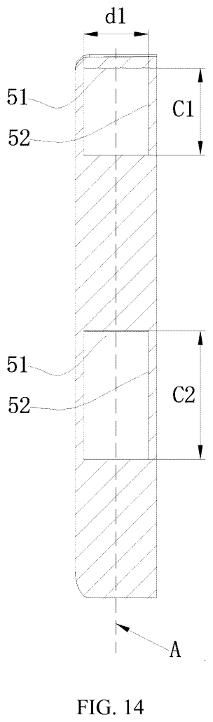

In some embodiments, as shown in FIG. 14, the reference plane A is a flat plane. The acoustic channel 32 extends along the length direction and the height direction of the temple 4, and the acoustic channel 32 is configured to be symmetrical with respect to the reference plane A. Therefore, the space in the temple 4 is sufficiently used, the volume of the acoustic channel 32 is larger, and the sound outputted from the sound output port 33 is more natural.

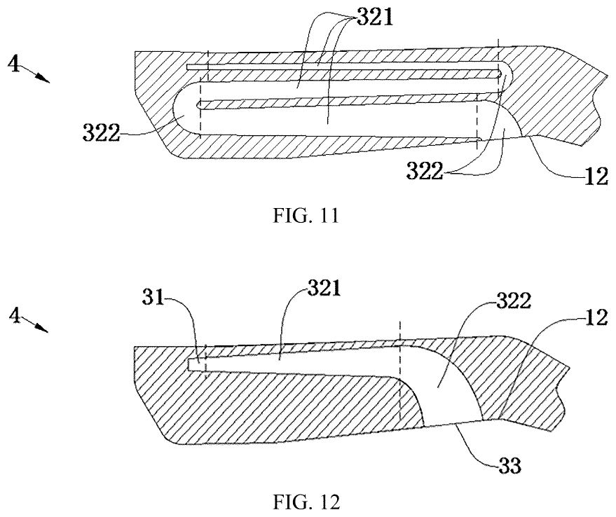

In some embodiments, as shown in FIG. 9, FIG. 10, and FIG. 11, the acoustic channel 32 extends to the sound output port 33 in a S-shape or U-shape. The acoustic channel 32 includes a plurality of straight sections 321 spaced apart from each other, and two adjacent straight sections 321 of the plurality of straight sections are connected by the curved section 322.

In the present embodiment, before the sound wave is outputted from the sound output port 33, the sound wave is propagated along the length direction of the temple 4 for at least two times, thereby increasing the length of the acoustic channel 32, improving the convergence of sound wave, and improving the sound amplification effect.

FIG. 9 and FIG. 10 show an example acoustic channel 32 including two straight sections 321 and two curved sections 322. The sound wave is propagated in the acoustic channel 32 from the first end of the temple 4 to the second end of the temple 4, then passes the curved section 322 with an arc of 180 degrees, then is propagated from the second end of the temple 4 to the first end of the temple 4 along the length direction of the temple 4, and then reaches the sound output port 33.

FIG. 11 shows another example acoustic channel 32 including three straight sections 321 and three curved sections 322. The sound wave is propagated in the acoustic channel 32 along the length direction of the temple 4, and reaches the sound output port 33 after passing the three curved sections 322.

FIG. 12 shows another example acoustic channel 32 including one straight section 321 and one curved section 322. The accommodating room 31 and the curved section 322 are arranged at two ends of the straight section 321, respectively, and the end of the curved section 322 away from the straight section 321 extends to the bottom of the temple 4 and forms the sound output port 33.

In this embodiment, the length of the acoustic channel 32 is reduced, so the cross-sectional area of the acoustic channel 32 may be configured larger, and the curved index may be smaller accordingly. As a result, the wearing part 1 has a better sound amplification effect, and the manufacturing difficulty of the wearing part 1 is reduced.

In some embodiments, as shown in FIG. 9, FIG. 10, and FIG. 11, the sound output port 33 is arranged close to the car hanging region 12, and the accommodating room 31 is communicated with the straight section 321 close to the top of the temple 4. In the present embodiment, the sound output port 33 is arranged adjacent to the car hanging region 12, so the sound from the car hanging region 12 is closer to the car of the user, the sound received by the car of the user is clearer, and the influence to surroundings is reduced. In addition, the sound output port 33 is arranged to face the car of the user, thereby improving the directivity of the sound wave.

In some embodiments, as shown in FIG. 9 and FIG. 10, the acoustic channel 32 of the headset extends along a U shape. A cross-sectional area of the first port of the acoustic channel 32 is 16.619 mm², the cross-sectional area of the second port of the acoustic channel 32 is 96.549 mm², the length of the acoustic guiding tube 111 is 0.1955 m, and the curved index is 9.

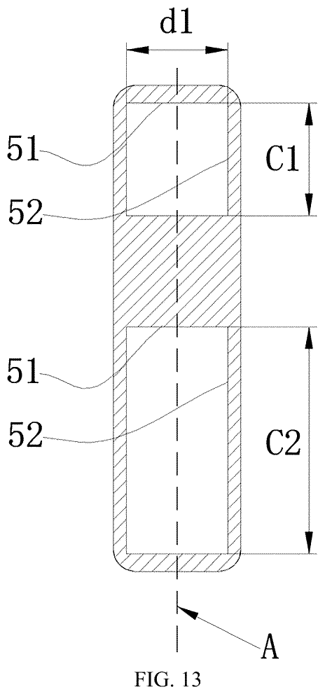

FIG. 13 is a cross-sectional view taken along line C-C in FIG. 9. FIG. 14 is a cross-sectional view taken along line D-D in FIG. 10.

In some embodiments, as shown in FIG. 13 and FIG. 14, the cross section, perpendicular to the extending direction of the acoustic channel 32, of the acoustic channel 32 is a rectangle, and the rectangle includes first edges 51 and second edges 52 perpendicular to the first edges 51. The first edge 51 is perpendicular to the reference plane A. In addition, along the extending direction of the acoustic channel 32, the length of the first edge 51 is constant (the distance d1 is constant). That is, as the cross section of the acoustic guiding tube 111 is closer to the sound output port 33, the length of the second edge 52 is progressively larger (the distance C1 is greater than the distance C2).

For example, the temple 4 in the present embodiment includes a top surface and a bottom surface, the distance between the top surface and the bottom surface is the height of the temple 4, and the height of the temple 4 is greater than the thickness of the temple 4. In this embodiment, the cross section of the acoustic channel 32 is a rectangle, and therefore, the space in the temple 4 is fully used and the volume of the acoustic channel 32 is increased. In addition, the length of the first edge 51 is constant rather than changes as the depth of the acoustic channel 32 changes. Therefore, the cross-sectional area of the acoustic channel 32 can be controlled more accurately, and the manufacturing difficulty is reduced.

The above embodiments are exemplary embodiments of the present disclosure and are not intended to limit the present disclosure. The present disclosure may be subject to various modifications and variations to those skilled in the art. Any modifications, equivalent substitutions or improvements that are within the spirit and principle of the disclosure are intended to be covered by the protection scope of the disclosure.

I/We claim:

1. A headset, comprising:
a speaker comprising a diaphragm; and
a wearing part comprising a cavity and a sound output port,
wherein the cavity comprises an accommodating room and an acoustic channel, a first end of the acoustic channel extends to the accommodating room, a second end of the acoustic channel is communicated with the sound output port, the speaker is arranged in the accommodating room, and the diaphragm faces the acoustic channel,
wherein at least a segment of the acoustic channel extends curvedly in a reference plane, and in the extending direction of the acoustic channel, a sectional area of the acoustic channel at a position close to the sound output port is greater than a sectional area of the acoustic channel at a position away from the sound output port.

2. The headset according to claim 1, wherein the wearing part comprises a housing, the cavity is defined by the housing, an outer surface of the housing is provided with an ear hanging region and the sound output port, and the acoustic channel extends to the sound output port.

3. The headset according to claim 1, wherein the ear hanging region is above the reference plane.

4. The headset according to claim 2, wherein the housing comprises an acoustic guiding tube, and an inner wall of the acoustic guiding tube forms the acoustic channel,
in the extending direction, the acoustic guiding tube comprises a first curved segment extending in the reference plane, and the first curved segment forms the ear hanging region.

5. The headset according to claim 4, wherein the reference plane comprises a reference point,
in the extending direction, the acoustic guiding tube further comprises a second curved segment extending in the reference plane, and the second curved segment is connected to an end of the first curved segment away from the sound output port,
both the first curved segment and the second curved segment surround the reference point and are curved in a direction away from the reference point, and a portion of the second curved segment is disposed opposite to the ear hanging region and spaced apart from the ear hanging region.

6. The headset according to claim 5, wherein the first curved segment and the second curved segment are symmetrical with respect to the reference plane.

7. The headset according to claim 6, wherein a curved degree of the second curved segment is less than a curved degree of the first curved segment, and a side of the second curved segment facing the first curved segment forms an avoidance space.

8. The headset according to claim 6, wherein a curved angle of the first curved segment with respect to the reference point is greater than or equal to 150 degrees and less than or equal to 180 degrees, and a curved angle of the second curved segment with respect to the reference point is greater than or equal to 115 degrees and less than or equal to 145 degrees.

9. The headset according to claim 5, wherein the housing further comprises a connection cap connecting to an end of the second curved segment away from the first curved segment, and the accommodating room is formed in the connection cap.

10. The headset according to claim 7, wherein in the extending direction, the acoustic guiding tube further comprises a third curved segment bent to a side of the reference plane, a first end of the third curved segment is connected to an end of the first curved segment away from the second curved segment, and the sound output port is formed at a second end of the third curved segment.

11. The headset according to claim 7, wherein a curved degree of the second curved segment is less than a curved degree of the first curved segment, and a side of the second curved segment facing the first curved segment forms an avoidance space.

12. The headset according to claim 2, wherein the wearing part comprises a temple, the temple comprises the acoustic channel and the ear hanging region, and the ear hanging region and the sound output port are both formed on a bottom of the temple.

13. The headset according to claim 12, wherein the acoustic channel extends along a length direction and a height direction of the temple, and the acoustic channel is configured to be symmetrical with respect to the reference plane.

14. The headset according to claim 12, wherein in the extending direction, the acoustic channel comprises at least one straight section and at least one curved section, a straight section of the at least one straight section extends along a length direction of the temple, and a curved section of the at least one curved section bends from the straight section toward the bottom of the temple.

15. The headset according to claim 14, wherein the acoustic channel extends to the sound output port in a S-shape or U-shape,
the at least one straight section comprises a plurality of straight sections spaced apart from each other, and adjacent two straight sections of the plurality of straight sections are connected by one of the at least one curved section.

16. The headset according to claim 15, wherein a number of the plurality of straight sections is two, a number of the at least one curved section is two, and one of the two curved section is curved by 180 degrees.

17. The headset according to claim 15, wherein a number of the plurality of straight sections is three, a number of the at least one curved section is three, and one of the three curved section is curved by 180 degrees.

18. The headset according to claim 14, wherein a number of the at least one straight section is one, a number of the at least one curved section is one, the accommodating room and the curved section are arranged at two ends of the straight section, respectively, and an end of the curved section away from the straight section extends to the bottom of the temple to form the sound output port.

19. The headset according to claim 14, wherein the sound output port is arranged close to the ear hanging region, and the accommodating room is communicated with the straight section close to a top of the temple.

20. The headset according to claim 12, wherein a cross section, perpendicular to the extending direction, of the acoustic channel is a rectangle, the rectangle comprises a first edge and a second edge perpendicular to each other, and the first edge is perpendicular to the reference plane,
in the extending direction of the acoustic channel, a length of the first edge is constant.
